(19) United States
(12) Patent Application Publication
(10) Pub. No.: US 2024/0371386 A1
(43) Pub. Date: Nov. 7, 2024

(54) AUDIO SOURCE SEPARATION FOR MULTI-CHANNEL BEAMFORMING BASED ON PERSONAL VOICE ACTIVITY DETECTION (VAD)

(71) Applicant: Synaptics Incorporated, San Jose, CA (US)

(72) Inventor: Saeed MOSAYYEBPOUR KASKARI, Irvine, CA (US)

(73) Assignee: Synaptics Incorporated, San Jose, CA (US)

(21) Appl. No.: 18/310,955

(22) Filed: May 2, 2023

(51) Int. Cl. G10L 21/0216; G10L 25/78

(52) U.S. Cl. CPC G10L 21/0216; G10L 25/78; G10L 2021/02087; G10L 2021/02166

(57) ABSTRACT

This disclosure provides methods, devices, and systems for speech enhancement. The present implementations more specifically relate to utilizing personal voice activity detectors (VADs) to suppress audio originating from a distractor audio source without distorting audio originating from a target audio source. In some aspects, a speech enhancement system may receive a multi-channel audio signal via a microphone array and may further generate, based on a neural network, an inference about whether a current frame of the audio signal includes speech from a known audio source. For example, the neural network may be a personal VAD that is trained to detect voice IDs associated with one or more target audio sources. In some implementations, the speech enhancement system may selectively steer a beam associated with a multi-channel beamformer toward a direction-of-arrival (DOA) of the current audio frame based, at least in part, on the inference.

### TECHNICAL FIELD

The present implementations relate generally to signal processing, and specifically to audio source separation for multi-channel beamforming based on personal voice activity detection (VAD).

### BACKGROUND OF RELATED ART

Beamforming is a signal processing technique that can focus the energy of signals transmitted or received in a spatial direction. For example, a beamformer can improve the quality of speech detected by a microphone array through signal combining at the microphone outputs. More specifically, the beamformer may apply a respective weight to the audio signal output by each microphone of the microphone array so that the signal strength is enhanced in the direction of the speech (or suppressed in the direction of noise) when the audio signals are combined. Adaptive beamformers are capable of dynamically adjusting the weights of the microphone outputs to optimize the quality, or the signal-to-noise ratio (SNR), of the combined audio signal. As such, an adaptive beamformer can adapt to changes in the environment. Example adaptive beamforming techniques include minimum mean square error (MMSE) beamforming, minimum variance distortionless response (MVDR) beamforming and generalized eigenvalue (GEV) beamforming, among other examples.

In far-field applications, adaptive beamformers may be unable to distinguish between speech originating from a target audio source (such as a user of the microphone array) and speech originating from a distractor audio source (such as a person speaking in the background). As a result, when the target audio source and the distractor audio source speak at the same time, an adaptive beamformer may fail to suppress the distractor speech as background noise. Thus, there is a need to improve the separation of target speech and distractor speech by adaptive beamformers in far-field applications.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of processing audio signals. The method includes receiving an audio signal via a plurality of microphones; generating, based on a neural network, an inference about whether a first frame of the received audio signal includes speech associated with a known audio source; and selectively steering a beam associated with a multi-channel beamformer toward a direction-of-arrival (DOA) of the first frame based at least in part on the inference about whether the first frame includes speech associated with a known audio source.

Another innovative aspect of the subject matter of this disclosure can be implemented in a speech enhancement system, including a processing system and a memory. The memory stores instructions that, when executed by the processing system, cause the speech enhancement system to receive an audio signal via a plurality of microphones; generate, based on a neural network, an inference about whether a first frame of the received audio signal includes speech associated with a known audio source; and selectively steer a beam associated with a multi-channel beamformer toward a DOA of the first frame based at least in part on the inference about whether the first frame includes speech associated with a known audio source.

### BRIEF DESCRIPTION OF THE DRAWINGS

The present implementations are illustrated by way of example and are not intended to be limited by the figures of the accompanying drawings.

FIG. 1 shows an example environment for which speech enhancement may be implemented.

FIG. 2 shows an example audio receiver that supports multi-channel beamforming.

FIG. 3 shows a block diagram of an example speech enhancement system, according to some implementations.

FIG. 4 shows a block diagram of an example target activity detector (TAD), according to some implementations.

FIG. 5 shows a block diagram of an example solo speaker detection system, according to some implementations.

FIG. 6 shows another block diagram of an example TAD, according to some implementations.

FIG. 7 shows another block diagram of an example speech enhancement system, according to some implementations.

FIG. 8 shows an illustrative flowchart depicting an example operation for processing audio signals, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, a beamformer can improve the quality of speech detected by a microphone array through signal combining at the microphone outputs. For example, the beamformer may apply a respective weight to the audio signal output by each microphone of the microphone array so that the signal strength is enhanced in the direction of the speech (or suppressed in the direction of noise) when the audio signals are combined. Adaptive beamformers are capable of dynamically adjusting the weights of the microphone outputs to optimize the quality, or the signal-to-noise ratio (SNR), of the combined audio signal. Example adaptive beamforming techniques include minimum mean square error (MMSE) beamforming, minimum variance distortionless response (MVDR) beamforming, and generalized eigenvalue (GEV) beamforming, among other examples.

In far-field applications, adaptive beamformers may be unable to distinguish between speech originating from a target audio source (such as a user of the microphone array) and speech originating from a distractor audio source (such as a person speaking in the background). As a result, when the target audio source and the distractor audio source speak at the same time, an adaptive beamformer may fail to suppress the distractor speech as background noise. Aspects of the present disclosure recognize that each speaker's voice has unique biometric characteristics (also referred to as a “voice ID”) that can be used to distinguish target speech from distractor speech. For example, a neural network may be trained or otherwise configured to determine whether an audio signal contains a voice ID associated with a known audio source (such as a target audio source). Such neural networks may be generally referred to as “personal voice activity detectors” or “personal VADs.”

Various aspects relate generally to speech enhancement, and more particularly, to utilizing personal VADs to suppress audio originating from a distractor audio source without distorting audio originating from a target audio source. In some aspects, a speech enhancement system may receive a multi-channel audio signal via a microphone array and may further generate, based on a neural network, an inference about whether a current frame of the audio signal includes speech from a known audio source. For example, the neural network may be a personal VAD that is trained to detect voice IDs associated with one or more target audio sources. In some implementations, the speech enhancement system may selectively steer a beam associated with a multi-channel beamformer toward a direction-of-arrival (DOA) of the current audio frame based, at least in part, on the inference. More specifically, the speech enhancement system may steer the beam toward the DOA of the current audio frame if the audio frame includes speech from a known audio source and may refrain from steering the beam toward the DOA of the current audio frame if the audio frame does not include speech from a known audio source.

Particular implementations of the subject matter described in this disclosure can be implemented to realize one or more of the following potential advantages. By utilizing a personal VAD to determine whether each frame of an audio signal includes speech from a target audio source, aspects of the present disclosure may enhance the quality of speech detected from far-field audio sources. More specifically, the speech enhancement system of the present implementations may utilize the inferences produced by the personal VAD to verify or validate the beam direction adopted by an adaptive beamformer. For example, the speech enhancement system may steer the beam associated with the multi-channel beamformer in the adopted beam direction when the adopted beam direction is aligned with a known (or target) audio source and may refrain from steering the beam in the adopted beam direction when the adopted beam direction is not aligned with any known audio sources. Unlike existing speech enhancement techniques that rely solely on adaptive beamforming, aspects of the present disclosure can separate target audio from distractor audio even in far-field applications.

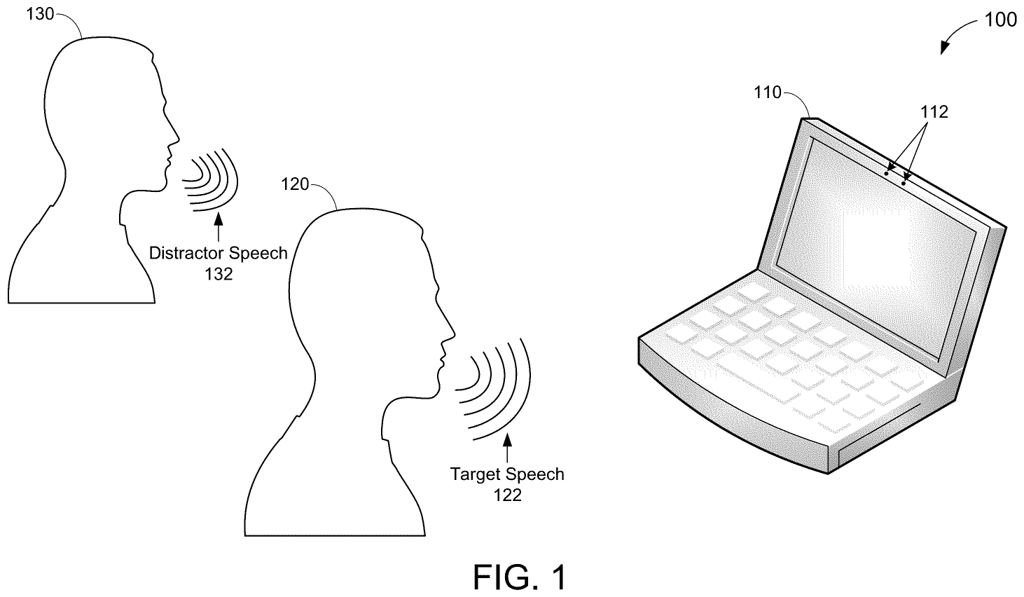

FIG. 1 shows an example environment 100 for which speech enhancement may be implemented. The example environment 100 includes a communication device 110, a user 120 of the communication device 110 (also referred to as a “target audio source” or “target source”), and a speaker 130 in the background (also referred to as a “distractor audio source” or “distractor source”). In some aspects, the communication device 110 may include multiple microphones 112 (also referred to as a “microphone array”). In the example of FIG. 1, the communication device 110 is shown to include two microphones 112. However, in actual implementations, the communication device 110 may include additional microphones (not shown for simplicity).

The microphones 112 are positioned or otherwise configured to detect acoustic waves, including target speech 122 and distractor speech 132, propagating through the environment 100. For example, the target speech 122 may include any sounds produced by the user 120. By contrast, the distractor speech 132 may include any sounds produced by the background speaker 130 as well as any other sources of background noise (not shown for simplicity). The microphones 112 may convert the detected acoustic waves to an electrical signal (also referred to as an “audio signal”) representative of the acoustic waveform. Accordingly, each audio signal may include a speech component (representing the target speech 122) and a noise component (representing the distractor speech 132). Due to differences in spatial positioning, sounds detected by one of the microphones 112 may be delayed relative to the sounds detected by the other microphone. In other words, the microphones 112 may produce audio signals with varying phase offsets.

In some aspects, the communication device 110 may include a multi-channel beamformer that weights and combines the audio signals produced by each of the microphones 112 to enhance the speech component or suppress the noise component. More specifically, the weights applied to the audio signals may improve the signal strength or SNR in a direction of the target speech 122. Such signal processing techniques are generally referred to as “beamforming.” In some implementations, an adaptive beamformer may estimate (or predict) a set of weights to be applied to the audio signals (also referred to as a “beamforming filter”) that steers the beam in the direction of the target speech 122. The quality of speech in the resulting signal depends on the accuracy of the beamforming filter. For example, the speech component may be enhanced if the beam direction is aligned with a direction of the user 120. On the other hand, the speech component may be distorted or suppressed if the beam direction is aligned with a direction of the background speaker 130 (or any direction away from the user 120).

In near-field applications (such as where the user 120 is very close to the microphones 122 while the background speaker 130 is significantly farther from the microphones 122), the SNR of the target speech 122 may be substantially higher than the SNR of the distractor speech 132. As such, a voice activity detector (VAD) can be used to distinguish between speech originating from a target audio source and speech originating from a distractor audio source. In far-field applications (such as where the user 120 and the background speaker 130 are relatively far from the microphones 122), the SNR of the target speech 122 may be similar to the SNR of the distractor speech 132. As such, existing VADs may be unable to distinguish between speech originating from a target audio source and speech originating from a distractor audio source. In other words, an adaptive beamformer may be unable to discern whether the user 120 or the background speaker 130 is the target audio source. As a result, the adaptive beamformer may adopt beam directions that enhance target speech and distractor speech.

Aspects of the present disclosure recognize that the user 120 may have a unique voice ID (based on biometric characteristics of the user's voice) that can be used to distinguish target speech 122 from distractor speech 132. For example, a neural network may be trained or otherwise configured to detect the voice ID of the user 120 in audio signals received via the microphones 112. Such neural networks may be generally referred to as “personal voice activity detectors” or “personal VADs.” In some aspects, the communication device 110 may determine whether the beam direction adopted by an adaptive beamformer is aligned with a direction of the user 120 based on an inference produced by a personal VAD. For example, the inference may indicate whether the received audio signal, from which the beam direction is adopted, includes a voice ID associated with the user 120. In other words, the communication device 110 may utilize the inference produced by the personal VAD to verify that the user 120 is speaking before steering the beam associated with the multi-channel beamformer in the direction of the detected speech.

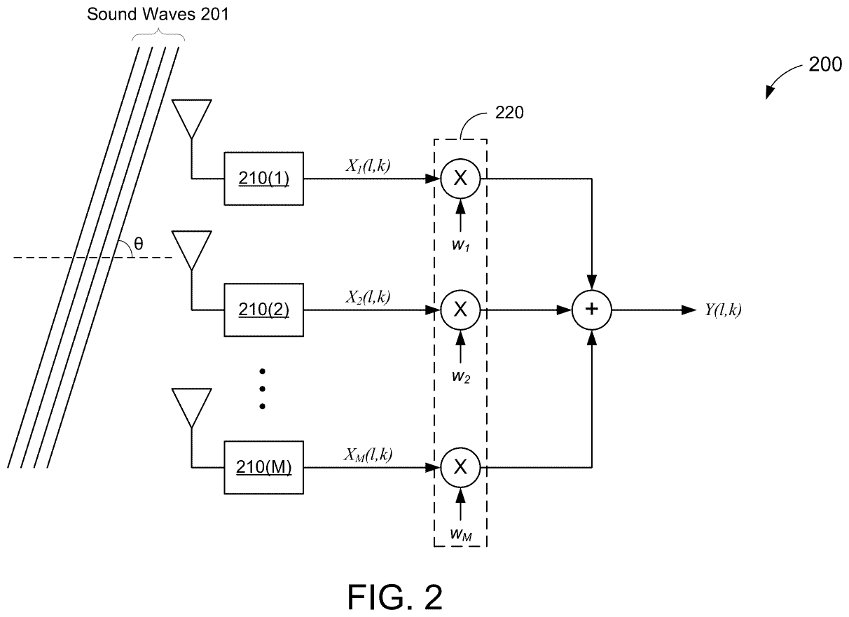

FIG. 2 shows an example audio receiver 200 that supports multi-channel beamforming. The audio receiver 200 includes a number (M) of microphones 210(1)-210(M), arranged in a microphone array, and a beamforming filter 220. In some implementations, the audio receiver 200 may be one example of the communication device 110 of FIG. 1. With reference for example to FIG. 1, each of the microphones 210(1)-210(M) may be one example of any of the microphones 112.

The microphones 210(1)-210(M) are configured to convert a series of sound waves 201 (also referred to as “acoustic waves”) into audio signals X₁(l, k)-X_{M}(l, k), respectively, where l is a frame index and k is a frequency index associated with a time-frequency domain. As shown in FIG. 2, the sound waves 201 are incident upon the microphones 210(1)-210(M) at an angle (θ). The angle θ also may be referred to as the “direction-of-arrival” (DOA) of the audio signals X₁(l, k)-X_{M}(l, k). In some implementations, the sound waves 201 may include target speech (such as the target speech 122 of FIG. 1) mixed with distractor speech (such as the distractor speech 132 of FIG. 1). The target speech and distractor speech represent a speech component (S(l, k)) and a noise component (N(l, k)), respectively, in each of the audio signals X₁(l, k)-X_{M}(l, k).

Due to the spatial positioning of the microphones 210(1)-210(M), each of the audio signals X₁(l, k)-X_{M}(l, k) may represent a delayed version of the same audio signal. For example, using the first audio signal X₁(l, k) as a reference audio signal, each of the remaining audio signals X₂(l, k)-X_{M}(l, k) can be described as a phase-delayed version of the first audio signal X₁(l, k). Accordingly, the audio signals X₁(l, k)-X_{M}(l, k) can be modeled as a vector (X(l, k)):

$$X ( l , k ) = a ( θ , k ) S ( l , k ) + N ( l , k ) \qquad ( 1 )$$

where X(l, k)=[X₁(l, k), . . . , X_{M}(l, k)] T is a multi-channel audio signal and a(θ, k) is a steering vector which represents the set of phase-delays for a sound wave 201 incident upon the microphones 210(1)-210(M).

The beamforming filter 220 applies a vector of weights w(l, k)=[w₁(l, k), . . . , w_{M}(l, k)]^{T} (where w₁-w_{M} are referred to as filter coefficients) to the audio signal X(l, k) to produce an enhanced audio signal (Y(l, k)):

$$Y ( l , k ) = {w}^{H} ( l k ) X ( l , k ) = {w}^{H} ( l , k ) a ( θ , k ) S ( l , k ) + {w}^{H} ( l , k ) N ( l , k ) \qquad ( 2 )$$

The vector of weights w(l, k) determines the direction of a “beam” associated with the beamforming filter 220. Thus, the filter coefficients w₁-w_{M} can be adjusted to “steer” the beam in various directions.

In some aspects, an adaptive beamformer (not shown for simplicity) may determine a vector of weights w(l, k) that optimizes the enhanced audio signal Y(l, k) with respect to one or more conditions. For example, an MVDR beamformer is configured to determine a vector of weights w(l, k) that reduces or minimizes the variance of the noise component of the enhanced audio signal Y(l, k) without distorting the speech component of the enhanced audio signal Y(l, k). In other words, the vector of weights w(l, k) may satisfy the following condition:

argmin_{w}w^{H}(l,k)ϕ_{NN}(l,k)w(l,k)s.t. w^{H}(l,k)a(θ,k)=1

where ϕ_{NN}(l, k) is the covariance of the noise component N(l, k) of the received audio signal X(l, k). The resulting vector of weights w(l, k) is an MVDR beamforming filter (w_{MVDR}(k)), which can be expressed as:

$${w}_{MVDR} ( l , k ) = \frac{{Φ}_{NN}^{- 1} ( l , k ) a ( θ , k )}{{a}^{H} ( θ , k ) {Φ}_{NN}^{- 1} ( l , k ) a ( θ , k )} \qquad ( 3 )$$

As shown in Equation 3, some MVDR beamformers may rely on geometry (such as the steering vector a(θ, k)) to determine the vector of weights w(l, k). As such, the accuracy of the MVDR beamforming filter w_{MVDR}(l, k) depends on the accuracy of the steering vector a(θ, k) estimation, which may be difficult to adapt to different users. Aspects of the present disclosure recognize that the MVDR beamforming filter w_{MVDR}(l, k) also can be expressed as a function of the covariance (ϕ_{SS}(l, k)) of the speech component S(l, k):

$${W}_{MVDR} ( l , k ) = \frac{W ( l , k )}{{W}_{norm} ( l , k )} u ( l , k ) \qquad ( 4 )$$

$$W ( l , k ) = {Φ}_{NN}^{- 1} ( l , k ) {Φ}_{SS} ( l , k ) \qquad ( 5 )$$

where u(l, k) is the one-hot vector representing a reference microphone channel and Wₙₒᵣₘ(l, k) is a normalization factor associated with W(l, k). Example suitable normalization factors include, among other examples, Wₙₒᵣₘ(l, k)=max(|W(l, k)|) and Wₙₒᵣₘ(l, k)=trace(W(l, k)).

In some aspects, the noise covariance ϕ_{NN}(l, k) and the speech covariance ϕ_{SS}(l, k) may be estimated or updated over time through supervised learning. For example, the speech covariance ϕ_{SS}(l, k) can be estimated when speech is present in the received audio signal X(l, k) and the noise covariance ϕ_{NN}(l, k) can be estimated when speech is absent from the received audio signal X(l, k). In some implementations, a deep neural network (DNN) may be used to determine whether speech is present or absent in the audio signal X(l, k). For example, the DNN may be trained to infer a likelihood or probability of speech in each frame of the audio signal X(l, k). As described with reference to FIG. 1, conventional VADs may be unable to separate target speech from distractor speech in far-field applications. Thus, in some implementations, the adaptive beamformer may rely on inferences produced by a personal VAD to determine the covariances ϕ_{SS}(l, k) and ϕ_{NN}(l, k).

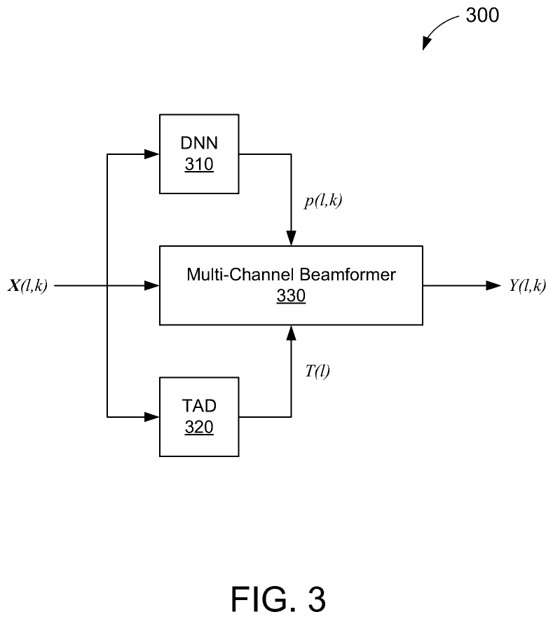

FIG. 3 shows a block diagram of an example speech enhancement system 300, according to some implementations. The speech enhancement system 300 is configured to produce an enhanced audio signal Y(l, k) based on a multi-channel audio signal X(l, k) received via a microphone array. With reference for example to FIG. 2, the multi-channel audio signal X(l, k) may be one example of the audio signals X₁(l, k)−X_{M}(l, k) received via the microphones 210(1)-210(M).

The speech enhancement system 300 includes a DNN 310, a target activity detector (TAD) 320, and a multi-channel beamformer 330. The DNN 310 is configured to infer a probability of speech p(l, k) in each frame l of the audio signal X(l, k) based on a neural network model, where 0≤p(l, k)≤1. For example, during a training phase, the DNN 310 may be provided with a large volume of audio signals containing speech mixed with background noise. The DNN 310 also may be provided with clean speech signals representing only the speech component of the audio signal (without background noise). The DNN 310 compares the audio signals with the clean speech signals to determine a set of features that can be used to classify speech. During an inferencing phase, the DNN 310 infers a probability of speech in each frame l of the audio signal X(l, k), at each frequency index k, based on the classification results. Examples suitable DNNs include convolutional neural networks (CNNs) and recurrent neural networks (RNNs), among other examples.

The TAD 320 is configured to determine or predict whether each frame l of the audio signal X(l, k) originates from a target audio source. An audio frame is said to “originate” from a given audio source only if the audio frame includes speech associated with the audio source and does not include speech associated with any other audio sources. In some implementations, the TAD 320 may determine whether the audio signal X(l, k) includes speech associated with a target audio source based on a personal VAD. For example, the personal VAD may be a neural network that is trained to detect a voice ID associated with the target audio source.

Aspects of the present disclosure recognize that some audio signals may include speech associated with multiple audio sources (such as a target source and a distractor source). As such, some audio frames may not originate from a target audio source even if the audio frames include speech associated with the target audio source. Thus, in some implementations, the TAD 320 may further determine whether each frame l of the audio signal X(l, k) includes speech associated with multiple audio sources. For example, the TAD 320 may include a neural network model that is trained to detect a presence of two or more voices in each audio frame.

The TAD 320 may further output a target activity value (T(l)) based on whether the audio frame includes speech associated with the target audio source and whether the audio frame includes speech associated with multiple audio sources. In some implementations, the target activity value T(l) may indicate that the audio frame originates from a target audio source if the audio frame includes speech associated with the target audio source and does not include speech associated with multiple audio sources. In some other implementations, the target activity value T(l) may indicate that the audio frame does not originate from a target audio source if the audio frame does not include speech associated with a target audio source or if the audio frame includes speech associated with multiple audio sources.

The multi-channel beamformer 330 is configured to apply a vector of weights w(l, k) to the audio signal X(l, k) to produce the enhanced audio signal Y(l, k) (such as according to Equation 2). In some implementations, the multi-channel beamformer 330 may be an adaptive beamformer that determines the vector of weights w(l, k) to apply to each frame l of the audio signal X(l, k) based, at least in part, on the probability of speech p(l, k) and the target activity value T(l) associated with the respective audio frame. As shown in Equations 4 and 5, an MVDR beamforming filter w_{MVDR}(l, k) can be determined based on the covariance of noise ϕ_{NN}(l, k) and the covariance of speech ϕ_{SS}(l, k) in the audio signal X(l, k). In some aspects, the multi-channel beamformer 330 may dynamically update the speech covariance ϕ_{SS}(l, k) and the noise covariance ϕ_{NN}(l, k) based on the probability of speech p(l, k) and the target activity value T(l) associated with the respective audio frame.

In some implementations, the multi-channel beamformer 330 may update the speech covariance ϕ_{SS}(l, k), based on the probability of speech p(l, k), when the target activity value T(l) indicates that the current audio frame originates from a target audio source (such as T(l)=1):

$${Φ}_{SS} ( l , k ) = ( 1 - p ( l , k ) ) {Φ}_{SS} ( l - 1 , k ) + p ( l , k ) ( X ( l , k ) {X}^{H} ( l , k ) ) if T ( l ) = 1$$

In some other implementations, the multi-channel beamformer 330 may update the noise covariance ϕ_{NN}(l, k), based on the probability of speech p(l, k), when the target activity value T(l) indicates that the current audio frame does not originate from a target audio source (such as T(l)=0):

$${Φ}_{NN} ( l , k ) = p ( l , k ) {Φ}_{NN} ( l - 1 , k ) + ( 1 - p ( l , k ) ) ( X ( l , k ) {X}^{H} ( l , k ) ) if T ( l ) = 0$$

Aspects of the present disclosure recognize that an adaptive beamformer may sometimes adopt a beam direction that is aligned with a distractor audio source. In some aspects, the multi-channel beamformer may use the target activity value T(l) to determine or verify whether the adopted beam direction is aligned with a target audio source. In other words, the multi-channel beamformer 330 may selectively steer its beam in the adopted beam direction based on the target activity value T(l). In some implementations, the multi-channel beamformer 330 may steer its beam in the adopted beam direction when the target activity value T(l) indicates that the current frame of the audio signal X(l, k) originates from a target audio source.

In some other implementations, the multi-channel beamformer 330 may refrain from steering its beam in the adopted beam direction when the target activity value T(l) indicates that the current frame of the audio signal X(l, k) does not originate from a target audio source. In such implementations, the multi-channel beamformer 330 may be bypassed (so that beamforming is not performed on the current audio frame) when the target activity value T(l) indicates that the current frame of the audio signal X(l, k) does not originate from a target audio source. Alternatively, the multi-channel beamformer 330 may implement a beamforming filter w(l, k) known to be aligned with a target audio source. For example, the multi-channel beamformer 330 may store the beam directions associated with known target audio sources to support faster beam adaptation.

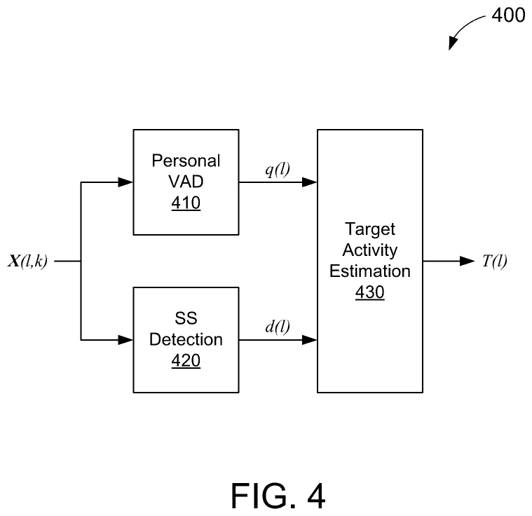

FIG. 4 shows a block diagram of an example TAD 400, according to some implementations. In some implementations, the TAD 400 may be one example of the TAD 320 of FIG. 3. More specifically, the TAD 400 may be configured to determine or predict whether each frame l of a multi-channel audio signal X(l, k) originates from a target audio source based on a probability of speech p(l, k) associated with the audio frame. For example, the probability of speech p(l, k) may be inferred by a DNN that is trained to detect speech in the audio signal X(l, k) (such as the DNN 310 of FIG. 3).

The TAD 400 includes a personal VAD 410, a solo speaker (SS) detection component 420, and a target activity estimation component 430. The personal VAD 410 is configured to produce an inference (q(l)) for each frame l of the audio signal X(l, k) based on whether the audio frame includes speech associated with a known audio source. For example, the personal VAD 410 may include a neural network that is trained to detect the voice IDs of one or more known audio sources in each audio frame. Thus, the inference q(l) may indicate that the audio frame includes speech associated with a known audio source if the personal VAD 410 detects a voice ID in the audio frame.

In some implementations, the TAD 400 may be configured to operate in a single-user mode. In such implementations, the personal VAD 410 may search the audio signal X(l, k) for a particular voice ID associated with a single audio source (also referred to as the “target voice ID”). In other words, the inference q(l) may indicate that the current frame of the audio signal X(l, k) includes speech associated with a known audio source only if the personal VAD 410 detects the target voice ID in the current audio frame.

In some other implementations, the TAD 400 may be configured to operate in a conference mode. In such implementations, the personal VAD 410 may search the audio signal X(l, k) for voice IDs associated with multiple audio sources (also referred to as “conference voice IDs”). In other words, the inference q(l) may indicate that the current frame of the audio signal X(l, k) includes speech associated with a known audio source if the personal VAD 410 detects any of the conference voice IDs in the current audio frame.

Aspects of the present disclosure recognize that the accuracy of the inference q(l) may depend on the number of acoustic features extracted by the neural network. For example, when speech is first detected in the audio signal X(l, k), the personal VAD 410 may have low confidence in whether the speech matches the voice ID of a known audio source due to the limited availability of acoustic features for speech classification. However, the personal VAD 410 may become much more confident in its determination after analyzing the acoustic features across a threshold number of audio frames.

In some aspects, the personal VAD 410 may be trained to classify each frame l of the audio signal X(l, k) according to one of three classes: (1) voice ID detected, (2) no voice ID detected, or (3) undecided. In other words, the inference q(l) may be a ternary value indicating that (1) the audio frame includes speech associated with a known audio source (q(l)=1), (2) the audio frame does not include speech associated with any known audio sources (q(l)=0), or (3) the personal VAD 410 is undecided as to whether the audio frame includes speech associated with any known audio sources (q(l)=−1).

In some implementations, the personal VAD 410 may be trained using a cost function that supports many or one detection (MOOD). For example, the MOOD cost function may have a tunable hyperparameter that can enforce the voice ID classifier to produce only a single detection (or up to any number of detections) in a region of target (ROT), where the ROT is a region of an audio signal to be used as ground truth for training. In other words, the MOOD cost function may not penalize the neural network for failing to classify a given audio frame as “voice ID detected” or “no voice ID detected.” Rather, the MOOD cost function may penalize the neural network only if it fails to classify at least one audio frame as “voice ID detected” or “no voice ID detected” after processing a threshold number of audio frames (corresponding to the ROT).

The SS detection component 420 is configured to determine whether each frame l of the audio signal X(l, k) includes speech associated with exactly one audio source. In some implementations, the SS detection component 420 may include a neural network trained to detect a presence of two or more voices in each audio frame. More specifically, the neural network may produce an inference indicating whether the audio frame includes speech associated with multiple audio sources. In some implementations, the SS detection component 420 may produce a detection signal (d(l)) based, at least in part, on whether the audio frame includes speech associated with multiple audio sources.

In some aspects, the SS detection component 420 may be configured to classify each frame l of the audio signal X(l, k) according to one of three classes: (1) solo speaker detected, (2) zero or multiple speakers detected, or (3) undecided. In other words, the SS detection signal d(l) may be a ternary value indicating that (1) the audio frame includes speech associated with exactly one audio source (d(l)=1), (2) the audio frame does not include speech associated with exactly one audio source (d(l)=0), or (3) the SS detection component 420 is undecided as to whether the audio frame includes speech associated with exactly one audio source (d(l)=−1).

The target activity estimation component 430 is configured to produce a respective target activity value T(l) for each frame l of the audio signal X(l, k) based, at least in part, on the inference q(l) and the detection signal d(l). More specifically, the target activity estimation component 430 may estimate whether the beam direction adopted by an adaptive beamformer (such as the multi-channel beamformer 330 of FIG. 3) matches the direction of a known audio source (or target audio source). In some implementations, the target activity value T(l) may be a ternary value, where:

$$T ( l ) = \{ \begin{matrix}1 & if q ( l ) = 1 and d ( l ) = 1 \\ - 1 & if q ( l ) = - 1 or d ( l ) = - 1 \\ 0 & otherwise\end{matrix}$$

In some implementations, the adaptive beamformer may steer its beam in the adopted beam direction when T(l)=1 and may refrain from steering its beam in the adopted beam direction when T(l)=0 or −1. As described with reference to FIG. 3, the multi-channel beamformer 330 may update the speech covariance ϕ_{SS}(l, k) when T(l)=1 and may update the noise covariance ϕ_{NN}(l, k) when T(l)=0. In some implementations, the multi-channel beamformer 330 may not update the speech covariance ϕ_{SS}(l, k) nor the noise covariance ϕ_{NN}(l, k) when T(l)=−1.

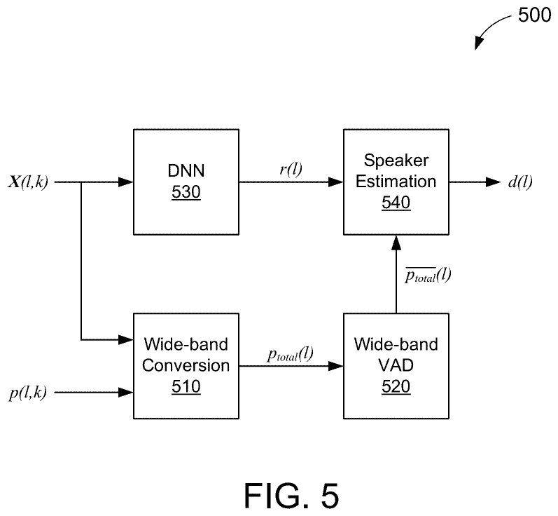

FIG. 5 shows a block diagram of an example solo speaker (SS) detection system 500, according to some implementations. In some implementations, the system 500 may be one example of the SS detection component 420 of FIG. 4. More specifically, the SS detection system 500 may be configured to determine whether each frame l of an audio signal X(l, k) includes speech associated with exactly one audio source based, at least in part, on a probability of speech p(l, k) associated with the audio frame. In some implementations, the probability of speech p(l, k) may be inferred by a DNN (such as the DNN 310 of FIG. 3).

The SS detection system 500 includes a wide-band conversion component 510, a wide-band VAD 520, a DNN 530, and a speaker estimation component 540. The wide-band conversion component 510 is configured to normalize the probability of speech p(l, k) across all frequency subbands k. In some implementations, the wide-band conversion component 510 may produce a wide-band probability of speech pₜₒₜₐₗ(l) as a function of the probability of speech p(l, k) and the audio signal X(l, k):

$${p}_{total} ( l ) = \frac{{\sum }_{f = {f}_{min}}^{{f}_{max}} p ( l , k ) X ( l , k )}{{\sum }_{f = {f}_{min}}^{{f}_{max}} X ( l , k )}$$

The wide-band VAD 520 is configured to convert the wide-band probability of speech pₜₒₜₐₗ(l) to a VAD value (p̅ₜ̅ₒ̅ₜ̅ₐ̅ₗ̅(l)) indicating whether speech is detected in the current frame of the audio signal X(l, k). In some implementations, the wide-band VAD 520 may determine that speech is present in the current audio frame only if the wide-band probability of speech pₜₒₜₐₗ(l) is greater than or equal to a first threshold probability (γ₀) and may determine that speech is absent from the current audio frame only if the wide-band probability of speech pₜₒₜₐₗ(l) is less than or equal to a second threshold probability (γ₁). In other words, the VAD value p̅ₜ̅ₒ̅ₜ̅ₐ̅ₗ̅(l) may be a ternary value, where:

$$\overline{{p}_{total}} ( l ) = \{ \begin{matrix}1 & if {p}_{total} ( l ) \geq {γ}_{0} \\ 0 & if {p}_{total} ( l ) \leq {γ}_{1} \\ - 1 & otherwise\end{matrix}$$

The DNN 530 is trained or otherwise configured to detect multiple voices in the current frame of the audio signal X(l, k). More specifically, the DNN 530 may produce an inference r(l) indicating whether multiple voices are detected in the current audio frame. In some implementations, the inference r(l) may be a binary value indicating that two or more voices are detected in the current audio frame (r(l)=1) or that one or no voice is detected in the current audio frame (r(l)=0).

The speaker estimation component 540 is configured to determine whether the current frame of the audio signal X(l, k) includes speech from exactly one audio source based on the inference r(l) and the VAD value p̅ₜ̅ₒ̅ₜ̅ₐ̅ₗ̅(l). More specifically, the speaker estimation component 540 may produce a detection signal d(l) indicating whether the current audio frame includes speech from exactly one audio source. In some implementations, the detection signal d(l) may be a ternary value, where:

$$d ( l ) = ( 1 - r ( l ) ) \overline{{p}_{total}} ( l )$$

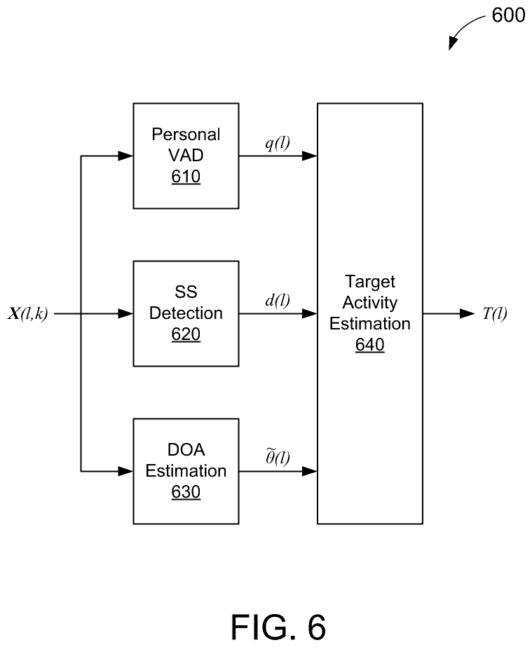

FIG. 6 shows another block diagram of an example TAD 600, according to some implementations. In some implementations, the TAD 600 may be one example of the TAD 320 of FIG. 3. More specifically, the TAD 600 may be configured to determine or predict whether each frame l of a multi-channel audio signal X(l, k) originates from a target audio source based on a probability of speech p(l, k) associated with the audio frame. For example, the probability of speech p(l, k) may be inferred by a DNN that is trained to detect speech in the audio signal X(l, k) (such as the DNN 310 of FIG. 3).

The TAD 600 includes a personal VAD 610, a solo speaker (SS) detection component 620, a direction-of-arrival (DOA) estimation component 630, and a target activity estimation component 640. The personal VAD 610 is configured to produce an inference q(l) for each frame l of the audio signal X(l, k) based on whether the audio frame includes speech associated with a known audio source. In some implementations, the personal VAD 610 may be one example of the personal VAD 410 of FIG. 4. For example, the personal VAD 610 may include a neural network that is trained to detect one or more voice IDs. Thus, the inference q(l) may indicate that the audio frame includes speech associated with a known audio source if the personal VAD 610 detects a voice ID in the audio frame.

In some implementations, the TAD 600 may be configured to operate in a single-user mode. In such implementations, the inference q(l) may indicate that the current frame of the audio signal X(l, k) includes speech associated with a known audio source only if the personal VAD 610 detects a target voice ID in the current audio frame (such as described with reference to FIG. 4). In some other implementations, the TAD 600 may be configured to operate in a conference mode. In such implementations, the inference q(l) may indicate that the current frame of the audio signal X(l, k) includes speech associated with a known audio source as long as the personal VAD 610 detects any conference voice ID in the current audio frame (such as described with reference to FIG. 4).

In some aspects, the personal VAD 610 may be trained to classify each frame l of the audio signal X(l, k) according to one of three classes: (1) voice ID detected, (2) no voice ID detected, or (3) undecided. In other words, the inference q(l) may be a ternary value indicating that (1) the audio frame includes speech associated with a known audio source (q(l)=1), (2) the audio frame does not include speech associated with any known audio sources (q(l)=0), or (3) the personal VAD 610 is undecided as to whether the audio frame includes speech associated with any known audio sources (q(l)=−1). In some implementations, the personal VAD 610 may be trained using a MOOD cost function (such as described with reference to FIG. 4).

The SS detection component 620 is configured to determine whether each frame l of the audio signal X(l, k) includes speech associated with exactly one audio source. In some implementations, the SS detection component 620 may be one example of the SS detection component 420 of FIG. 4 or the SS detection system 500 of FIG. 5. For example, the SS detection component 420 may include a neural network that is trained to detect a presence of two or more voices in each audio frame. In some implementations, the SS detection component 620 may produce a detection signal d(l) based, at least in part, on whether the audio frame includes speech associated with multiple audio sources (such as described with reference to FIG. 5).

In some aspects, the SS detection component 620 may be configured to classify each frame l of the audio signal X(l, k) according to one of three classes: (1) solo speaker detected, (2) zero or multiple speakers detected, or (3) undecided. In other words, the SS detection signal d(l) may be a ternary value indicating that (1) the audio frame includes speech associated with exactly one audio source (d(l)=1), (2) the audio frame does not include speech associated with exactly one audio source (d(l)=0), or (3) the SS detection component 620 is undecided as to whether the audio frame includes speech associated with exactly one audio source (d(l)=−1).

The DOA estimation component 630 is configured to estimate a DOA (\tilde{θ}(l)) of each frame l of the audio signal X(l, k). More specifically, the DOA estimation component 630 may estimate the beam direction adopted by an adaptive beamformer (such as the multi-channel beamformer 330 of FIG. 3) based on the received audio signal X(l, k). With reference for example to FIG. 2, the DOA \tilde{θ}(l) represents the angle (0) at which the sound waves 201 are incident upon the microphones 210(1)-210(M).

In some implementations, the DOA estimation component 630 may estimate the DOA \tilde{θ}(l) based on a delay between the audio signals X₁(l, k)-X_{M}(l, k) received via respective microphones of the microphone array. With reference for example to FIG. 2, the audio signals X₁(l, k) and X₂(l, k) received via the microphones 210(1) and 210(2), respectively, can be expressed as time-domain signals x₁(t) and x₂(t):

$$\begin{matrix}{x}_{1} ( t ) = s ( t ) + {n}_{1} ( t ) \\ {x}_{2} ( t ) = αs ( t + D ) + {n}_{2} ( t )\end{matrix}$$

where s(t) represents the speech component in each of the audio signals x₁(t) and x₂(t); n₁(t) and n₂(t) represent the noise components in the audio signals x₁(t) and x₂(t), respectively; a is an attenuation factor associated with the second audio signal x₂(t); and D is a delay between the first audio signal x₁(t) and the second audio signal x₂(t).

Aspects of the present disclosure recognize that the delay D can be determined by computing the cross correlation (Rₓ_{₁}ₓ_{₂}(τ) of the audio signals x₁(t) and x₂(t):

$${R}_{{x}_{1} {x}_{2}} ( τ ) = E [ {x}_{1} ( t ) {x}_{2} ( t - τ ) ]$$

where E[·] is the expected value, and the value of t that maximizes Rₓ_{₁}ₓ_{₂}(τ) provides an estimate of the delay D (and thus, the DOA \tilde{θ}(l)).

The target activity estimation component 640 is configured to produce a respective target activity value T(l) for each frame l of the audio signal X(l, k) based, at least in part, on the inference q(l), the detection signal d(l), and the DOA \tilde{θ}(l). More specifically, the target activity estimation component 640 may estimate whether the beam direction adopted by an adaptive beamformer (such as the multi-channel beamformer 330 of FIG. 3) matches the direction of a known audio source (or target audio source).

In some aspects, the target activity estimation component 640 may produce an intermediate activity value T₀(l) based on the inference q(l) and the detection signal d(l). In some implementations, the intermediate activity value T₀(l) may be a ternary value, where:

$${T}_{0} ( l ) = \{ \begin{matrix}1 & if q ( l ) = 1 and d ( l ) = 1 \\ - 1 & if q ( l ) = - 1 or d ( l ) = - 1 \\ 0 & otherwise\end{matrix}$$

In some implementations, the target activity value T(l) may indicate that the current frame of the audio signal X(l, k) originates from a target audio source when T₀(l)=1. In some other implementations, the target activity value T(l) may indicate that the current frame of the audio signal X(l, k) does not originate from a target audio source when T₀(l)=0. Still further, in some implementations, the target activity estimation component 640 may utilize the DOA \tilde{θ}(l) to resolve indecisions by the personal VAD 610 or the SS detection component 620 (such as when T₀(l)=−1).

In some aspects, the target activity estimation component 640 may compare the DOA P (l) to a set of target DOAs (D) that are known to be aligned with a target audio source. If the DOA \tilde{θ}(l) matches a target DOA (et) in the set D, the target activity value T(l) may indicate that the current frame of the audio signal X(l, k) originates from a target audio source when T₀(l)=−1. For example, a “match” may be detected if the DOA \tilde{θ}(l) is within a threshold range (4) of the target DOA et.

However, the DOA \tilde{θ}(l) may not be used to resolve indecisions by the personal VAD 610 or the SS detection component 620 if the DOA \tilde{θ}(l) does not match any target DOAs in the set D. Thus, in some implementations, the target activity value T(l) may be a ternary value based on the intermediate activity value T₀(l) and the DOA \tilde{θ}(l):

$$T ( l ) = \{ \begin{matrix}- 1 & if {T}_{0} ( l ) = - 1 and ∄ {θ}_{t} ∈ D : \vert \tilde{θ} ( l ) - {θ}_{t} \vert > Δ \\ 0 & if {T}_{0} ( l ) = 0 \\ 1 & otherwise\end{matrix}$$

In some aspects, the target activity estimation component 640 may dynamically update a set of target DOAs D based, at least in part, on the intermediate activity value T₀(l). In some implementations, the target activity estimation component 640 may add the DOA P (l), as a target DOA et, to the set D when T₀(l)=1. In some other implementations, the target activity estimation component 640 may update a target DOA et in the set D that matches the DOA \tilde{θ}(l) when T₀(l)=1. Still further, in some implementations, the target activity estimation component 640 may remove a target DOA et from the set D that matches the DOA \tilde{θ}(l) when T₀(l)=0.

In some implementations, the adaptive beamformer may steer its beam in the adopted beam direction when T(l)=1 and may refrain from steering its beam in the adopted beam direction when T(l)=0 or −1. As described with reference to FIG. 3, the multi-channel beamformer 330 may update the speech covariance ϕ_{SS}(l, k) when T(l)=1 and may update the noise covariance ϕ_{NN}(l, k) when T(l)=0. In some implementations, the multi-channel beamformer 330 may not update the speech covariance ϕ_{SS}(l, k) nor the noise covariance ϕ_{NN}(l, k) when T(l)=−1.

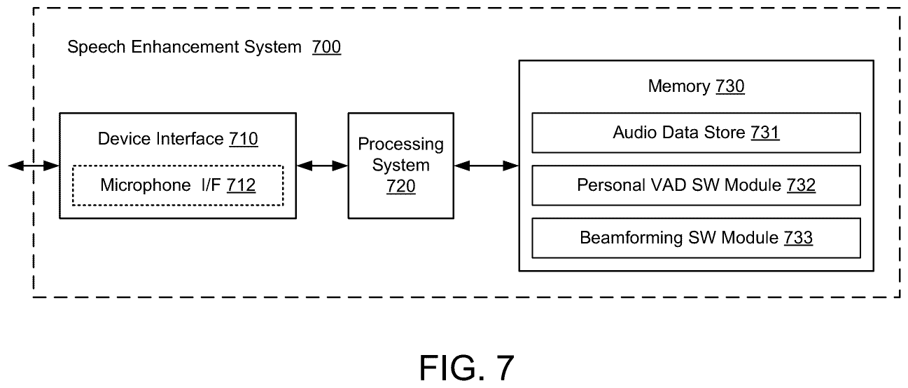

FIG. 7 shows another block diagram of an example speech enhancement system 700, according to some implementations. More specifically, the speech enhancement system 700 may be configured to receive a multi-channel audio signal and produce an enhanced audio signal by filtering or suppressing noise in the received audio signal based, at least in part, on voice IDs associated with known audio sources. In some implementations, the speech enhancement system 700 may be one example of the audio receiver 200 of FIG. 2 or the speech enhancement system 300 of FIG. 3.

The speech enhancement system 700 includes a device interface 710, a processing system 720, and a memory 730. The device interface 710 is configured to communicate with various components of the audio receiver. In some implementations, the device interface 710 may include a microphone interface (I/F) 712 configured to receive an audio signal via a plurality of microphones. For example, the microphone I/F 712 may sample or receive individual frames of the audio signal at a frame hop associated with the speech enhancement system 700.

The memory 730 may include an audio data store 731 configured to store one or more frames of the audio signal. The memory 730 also may include a non-transitory computer-readable medium (including one or more nonvolatile memory elements, such as EPROM, EEPROM, Flash memory, or a hard drive, among other examples) that may store at least the following software (SW) modules:
a personal VAD SW module 732 to generate, based on a neural network, an inference about whether a first frame of the received audio signal includes speech associated with a known audio source; and
a beamforming SW module 733 to selectively steer a beam associated with a multi-channel beamformer toward a DOA of the first frame based at least in part on the inference about whether the first frame includes speech associated with a known audio source.
   Each software module includes instructions that, when executed by the processing system 720, causes the speech enhancement system 700 to perform the corresponding functions.

The processing system 720 may include any suitable one or more processors capable of executing scripts or instructions of one or more software programs stored in the speech enhancement system 700 (such as in the memory 730). For example, the processing system 720 may execute the personal VAD SW module 732 to generate, based on a neural network, an inference about whether a first frame of the received audio signal includes speech associated with a known audio source. The processing system 720 also may execute the beamforming SW module 733 to selectively steer a beam associated with a multi-channel beamformer toward a DOA of the first frame based at least in part on the inference about whether the first frame includes speech associated with a known audio source.

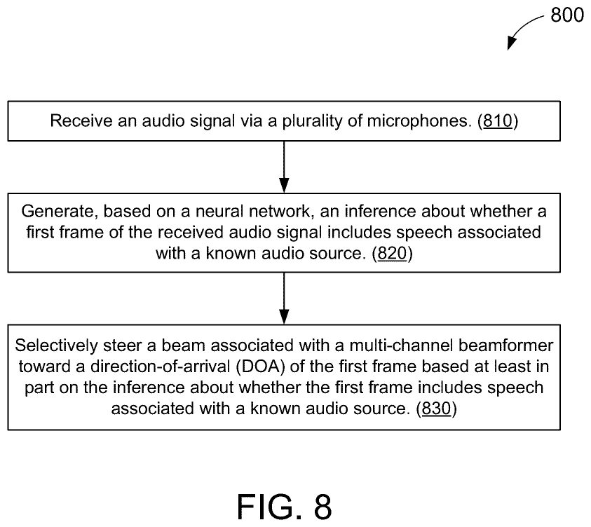

FIG. 8 shows an illustrative flowchart depicting an example operation 800 for processing audio signals, according to some implementations. In some implementations, the example operation 800 may be performed by a speech enhancement system (such as the audio receiver 200 of FIG. 2 or any of the speech enhancement systems 300 or 700 of FIGS. 3 and 7, respectively).

The speech enhancement system receives an audio signal via a plurality of microphones (810). The speech enhancement system generates, based on a neural network, an inference about whether a first frame of the received audio signal includes speech associated with a known audio source (820). In some implementations, the inference may be a ternary value indicating that the first frame includes speech associated with a known audio source, that the first frame does not include speech associated with a known audio source, or that the neural network is undecided as to whether the first frame includes speech associated with a known audio source.

Further, the speech enhancement system selectively steers a beam associated with a multi-channel beamformer toward a DOA of the first frame based at least in part on the inference about whether the first frame includes speech associated with a known audio source (830). In some implementations, the speech enhancement system may refrain from steering the beam toward the DOA of the first frame if the ternary value indicates that the first frame does not include speech associated with a known audio source or if the ternary value indicates that the neural network is undecided as to whether the first frame includes speech associated with a known audio source.

In some aspects, the speech enhancement system may further determine whether the first frame of the receive audio signal includes speech associated with multiple audio sources. In such aspects, the selective steering of the beam may be further based on whether the first frame includes speech associated with multiple audio sources. In some implementations, the speech enhancement system may refrain from steering the beam toward the DOA of the first frame if the first frame includes speech associated with multiple audio sources.

In some aspects, the speech enhancement system may further determine a probability of speech in the first frame of the received audio signal. In such aspects, the selective steering of the beam may be further based on the probability of speech in the first frame. In some implementations, the speech enhancement system may refrain from steering the beam toward the DOA of the first frame if the probability of speech in the first frame is less than a threshold probability. In some other implementations, the speech enhancement system may steer the beam toward the DOA of the first frame if the probability of speech in the first frame is greater than or equal to a threshold probability, the first frame does not include speech associated with multiple audio sources, and the ternary value indicates that the first frame includes speech associated with a known audio source.

In some aspects, the multi-channel beamformer may be an MVDR beamformer that reduces a power of a noise component of the audio signal without distorting a speech component of the audio signal. In some aspects, the speech enhancement system may further calculate a filter associated with the MVDR beamformer based on a covariance of the noise component of the audio signal and a covariance of the speech component of the audio signal. In some implementations, the speech enhancement system may refrain from determining the covariances of any of the speech component or the noise component of the audio signal when the probability of speech in the first frame is greater than a first threshold probability but less than a second threshold probability or the ternary value indicates that the neural network is undecided as to whether the first frame includes speech associated with a known audio source.

In some other implementations, the speech enhancement system may determine the covariance of the speech component of the audio signal when the probability of speech in the first frame is greater than or equal to a threshold probability, the first frame does not include speech associated with multiple audio sources, and the ternary value indicates that the first frame includes speech associated with a known audio source. Still further, in some other implementations, the speech enhancement system may determine the covariance of the noise component of the audio signal when the probability of speech in the first frame is less than a threshold probability, the first frame includes speech associated with multiple audio sources, or the ternary value indicates that the first frame does not include speech associated with a known audio source.

In some aspects, the speech enhancement system may further store the DOA of the first frame responsive to steering the beam toward the DOA of the first frame; determine a DOA of a second frame of the received audio signal; determine whether the DOA of the second frame is within a threshold range of the stored DOA; and selectively steer the beam toward the DOA of the second frame based at least in part on whether the DOA of the second frame is within the threshold range of the stored DOA.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of processing audio signals, comprising:
receiving an audio signal via a plurality of microphones;
generating, based on a neural network, an inference about whether a first frame of the received audio signal includes speech associated with a known audio source; and
selectively steering a beam associated with a multi-channel beamformer toward a direction-of-arrival (DOA) of the first frame based at least in part on the inference about whether the first frame includes speech associated with a known audio source.

2. The method of claim 1, wherein the inference comprises a ternary value indicating that the first frame includes speech associated with a known audio source, that the first frame does not include speech associated with a known audio source, or that the neural network is undecided as to whether the first frame includes speech associated with a known audio source.

3. The method of claim 2, wherein the selective steering of the beam comprises:
refraining from steering the beam toward the DOA of the first frame if the ternary value indicates that the first frame does not include speech associated with a known audio source or if the ternary value indicates that the neural network is undecided as to whether the first frame includes speech associated with a known audio source.

4. The method of claim 2, further comprising:
determining whether the first frame of the receive audio signal includes speech associated with multiple audio sources, the selective steering of the beam being further based on whether the first frame includes speech associated with multiple audio sources.

5. The method of claim 4, wherein the selective steering of the beam comprises:
refraining from steering the beam toward the DOA of the first frame if the first frame includes speech associated with multiple audio sources.

6. The method of claim 4, further comprising:
determining a probability of speech in the first frame of the received audio signal, the selective steering of the beam being further based on the probability of speech in the first frame.

7. The method of claim 6, wherein the selective steering of the beam comprises:
refraining from steering the beam toward the DOA of the first frame if the probability of speech in the first frame is less than a threshold probability.

8. The method of claim 6, wherein the selective steering of the beam comprises:
steering the beam toward the DOA of the first frame if the probability of speech in the first frame is greater than or equal to a threshold probability, the first frame does not include speech associated with multiple audio sources, and the ternary value indicates that the first frame includes speech associated with a known audio source.

9. The method of claim 6, wherein the multi-channel beamformer comprises a minimum variance distortionless response (MVDR) beamformer that reduces a power of a noise component of the audio signal without distorting a speech component of the audio signal.

10. The method of claim 6, further comprising:
calculating a filter associated with the MVDR beamformer based on a covariance of the noise component of the audio signal and a covariance of the speech component of the audio signal.

11. The method of claim 10, further comprising:
determining the covariance of the speech component of the audio signal when the probability of speech in the first frame is greater than or equal to a threshold probability, the first frame does not include speech associated with multiple audio sources, and the ternary value indicates that the first frame includes speech associated with a known audio source.

12. The method of claim 10, further comprising:
determining the covariance of the noise component of the audio signal when the probability of speech in the first frame is less than a threshold probability, the first frame includes speech associated with multiple audio sources, or the ternary value indicates that the first frame does not include speech associated with a known audio source.

13. The method of claim 10, further comprising:
refraining from determining the covariances of any of the speech component or the noise component of the audio signal when the probability of speech in the first frame is greater than a first threshold probability but less than a second threshold probability or the ternary value indicates that the neural network is undecided as to whether the first frame includes speech associated with a known audio source.

14. The method of claim 1, further comprising:
storing the DOA of the first frame responsive to steering the beam toward the DOA of the first frame;
determining a DOA of a second frame of the received audio signal;
determining whether the DOA of the second frame is within a threshold range of the stored DOA; and
selectively steering the beam toward the DOA of the second frame based at least in part on whether the DOA of the second frame is within the threshold range of the stored DOA.

15. A speech enhancement system comprising:
a processing system; and
a memory storing instructions that, when executed by the processing system, causes the speech enhancement system to:
receive an audio signal via a plurality of microphones;
generate, based on a neural network, an inference about whether a first frame of the received audio signal includes speech associated with a known audio source; and
selectively steer a beam associated with a multi-channel beamformer toward a direction-of-arrival (DOA) of the first frame based at least in part on the inference about whether the first frame includes speech associated with a known audio source.

16. The speech enhancement system of claim 15, wherein the inference comprises a ternary value indicating that the first frame includes speech associated with a known audio source, that the first frame does not include speech associated with a known audio source, or that the neural network is undecided as to whether the first frame includes speech associated with a known audio source.

17. The speech enhancement system of claim 16, wherein execution of the instructions further causes the speech enhancement system to:
determine whether the first frame of the receive audio signal includes speech associated with multiple audio sources, the selective steering of the beam being further based on whether the first frame includes speech associated with multiple audio sources.

18. The speech enhancement system of claim 17, wherein execution of the instructions further causes the speech enhancement system to:
determine a probability of speech in the first frame of the received audio signal, the selective steering of the beam being further based on the probability of speech in the first frame.

19. The speech enhancement system of claim 18, wherein the selective steering of the beam comprises:
steering the beam toward the DOA of the first frame only if the probability of speech in the first frame is greater than or equal to a threshold probability, the first frame does not include speech associated with multiple audio sources, and the ternary value indicates that the first frame includes speech associated with a known audio source.

20. The speech enhancement system of claim 15, wherein execution of the instructions further causes the speech enhancement system to:
store the DOA of the first frame responsive to steering the beam toward the DOA of the first frame;
determine a DOA of a second frame of the received audio signal;
determine whether the DOA of the second frame is within a threshold range of the stored DOA; and
selectively steer the beam toward the DOA of the second frame based at least in part on whether the DOA of the second frame is within the threshold range of the stored DOA.
